(19) United States
(12) Patent Application Publication
(10) Pub. No.: US 2003/0029798 A1
(43) Pub. Date: Feb. 13, 2003

(54) Membrane filtration system and method

(76) Inventor: Scott McLeod, Elbarta, AL (US)

Correspondence Address: Peter Loffler, 1546-1 Metropolitan Boulevard, Tallahassee, FL, 32308, US

(21) Appl. No.: 09/925,926

(22) Filed: Aug. 10, 2001

(51) Int. Cl. B01D 61/14

(52) U.S. Cl. 210/650; 210/321.75

(57) ABSTRACT

An oil filtration system uses a housing having an inlet port and an outlet port connected by a series of passages arranged in an S-flow pattern. Each passage is bounded on at least one side by a membrane filter which filter channels the permeate removed from the filter out of the system through permeate ports that are attached to each filter and that pass through an end cap of the housing. A turbulence creating flange is disposed within the passages for creating turbulence of the fluid flowing through the passages in order to increase fluid interaction with the filters and thus increase the filtration ability of the membrane filters.

### BACKGROUND OF THE INVENTION

1. Field of the Invention

The present invention relates to a membrane filtration system used to removal particle matter from oil and other similar fluids.

2. Background of the Prior Art

Used oils from automotive applications, industrial applications, etc., contain a number of contaminants. The removal of such contaminants is desirable in order to be able to reuse the oil in other applications. In order to remove these contaminants, several prior art filtration systems have been proposed. Such systems, which work with varying degrees of efficiency, are designed to remove particles above a desired size threshold depending upon the final application of the treated oil. The problem with many prior art systems is their inability to filter particles from the oil being treated that fall below a particular size. Some systems, while overcoming the size problem of particle size removal, tend to become clogged or otherwise filled during use, requiring frequent downtime in order to remove the contaminants from such systems. Still other prior art oil filtration systems work with a high degree of efficiency in filtering particles of almost any desired size from the oil being treated, yet such prior art devices are unusually complex in design and construction and are relatively difficult to use and maintain, resulting in relatively high acquisition and operational costs of such systems.

Therefore, there exists a need in the art for a filtration system that will filter contaminants from used oils which system overcomes the above-stated problems in the art. Specifically, such a filtration system must be able to filter particles of almost any size from the oil being filtered. The filtration system must not become readily clogged thereby reducing downtime and servicing of the system. The filtration system must be of relatively simple design and construction such that the filtration system is relatively inexpensive to manufacture, operate, and maintain.

### SUMMARY OF THE INVENTION

The membrane filtration system and method of the present invention address the aforementioned needs in the art. The oil filtration system and method are be able to filter particles of almost any size from the oil being filtered by the system. The membrane filtration system does not become readily clogged so that frequent downtime and servicing of the oil filtration system are avoided. The membrane filtration system is of relatively simple design and construction such that the filtration system is relatively inexpensive to manufacture, operate, and maintain.

The membrane filtration system of the present invention is comprised of a housing having a first end and a second end with a first end cap having an inlet port being attached to the first end of the housing and a second end cap having an outlet port being attached to the second end of the housing. A plurality of membrane filters are disposed within the housing in generally parallel fashion such that the membrane filters create a plurality of passages that are disposed within the housing in an S-flow pattern, the plurality of passages fluid flow connecting the inlet port with the outlet port. At least one flange is disposed within the plurality of passages for creating turbulence within the fluid that is flowing within the plurality of passages. The at least one flange can be disposed between a connection point between a respective two of the plurality of passages or elsewhere within the passages. Each membrane filter is a generally flat sheet member held within a frame and each frame is secured within a first guide attached to the first end cap and within a second guide attached to the second end cap. A plurality of permeate ports are provided and each permeate port is attached to a respective one of the membrane filters and each permeate port passes through the second end cap such that permeate collected by the respective membrane filter exits the housing through the permeate port.

### BRIEF DESCRIPTION OF THE DRAWINGS

FIG. 1 is a schematic flow diagram of the membrane filtration system and method of the present invention.

FIG. 2 is a perspective view of the membrane filtration system.

FIG. 3 is a perspective view of the first end cap used with the membrane filtration system and method.

FIG. 4 is a perspective view of the second end cap used with the membrane filtration system and method.

FIG. 5 is a perspective view of the housing of the membrane filtration system with the end cap removed.

FIG. 6 is a perspective view of a membrane filter.

FIG. 7 is a close-up view of a portion of the membrane filter.

FIG. 8 is a cross-section view of the membrane filtration system.

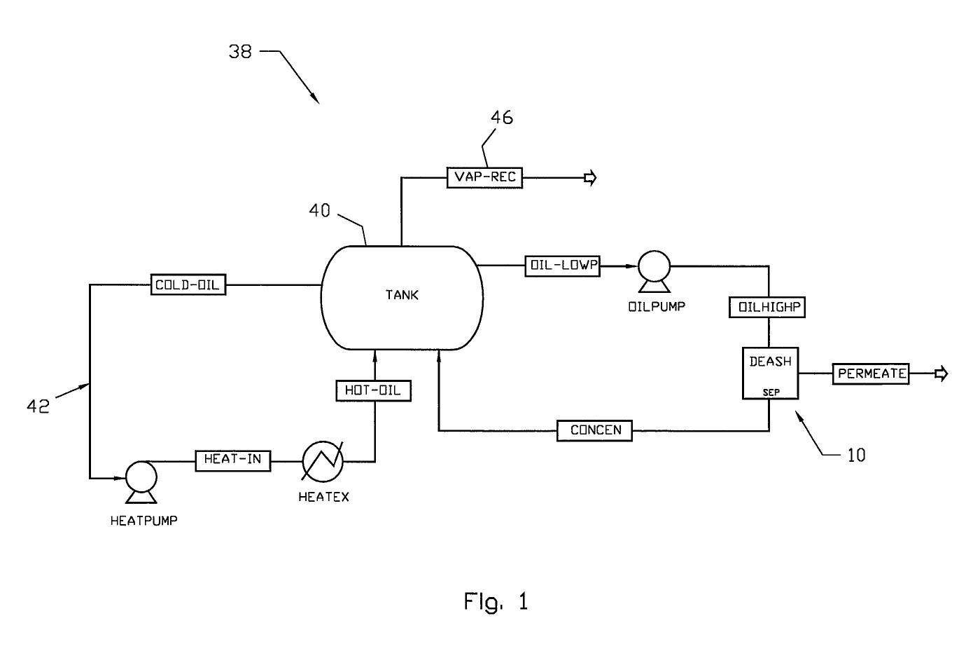

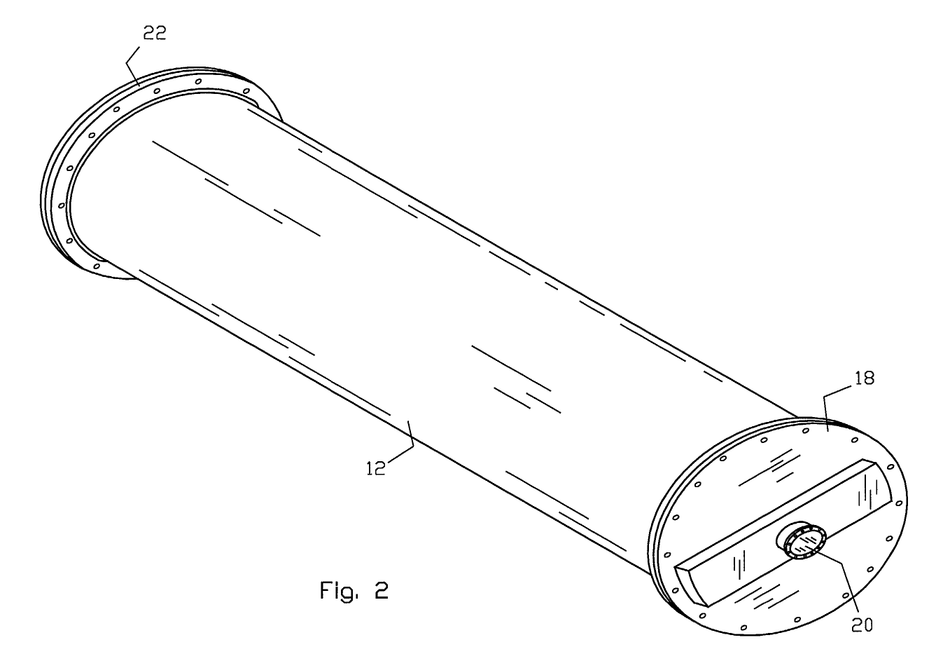

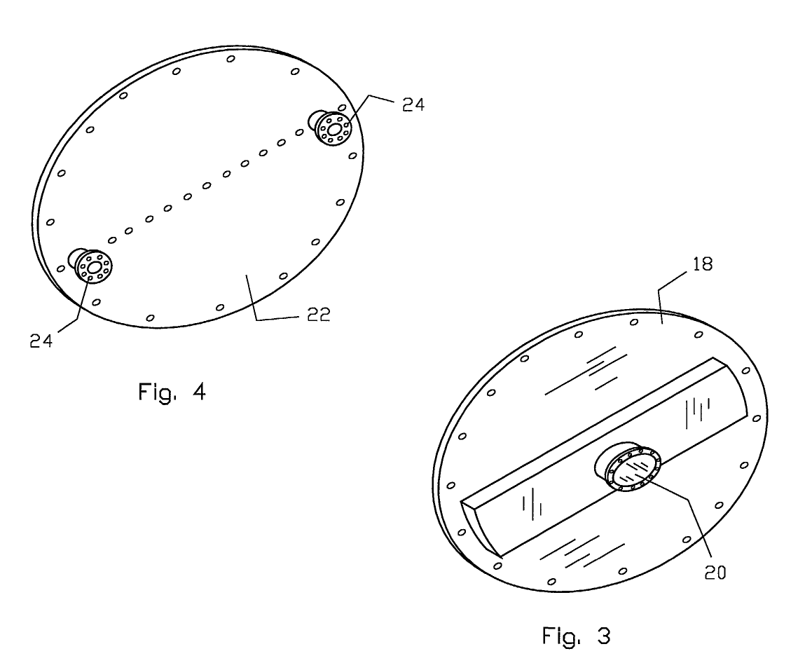

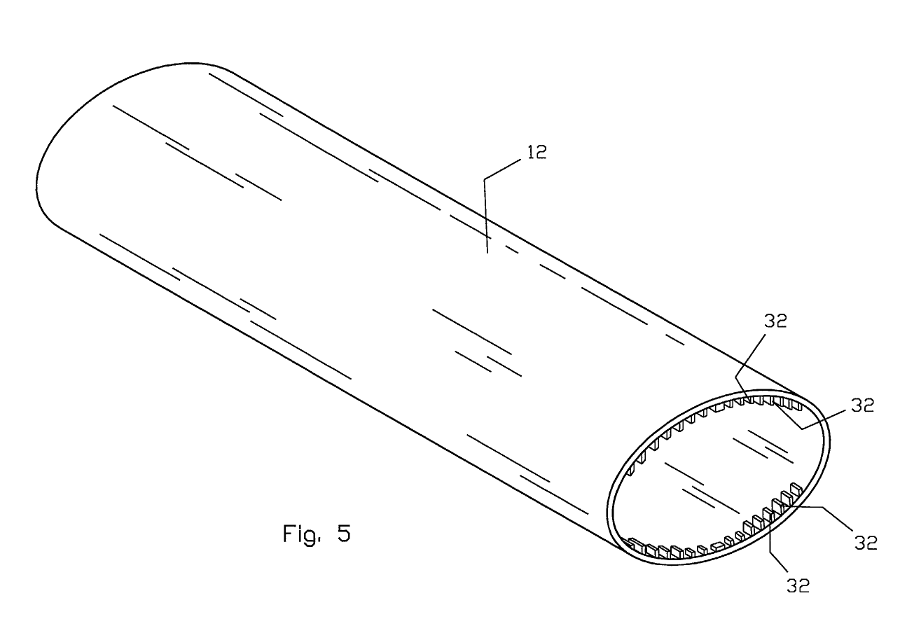

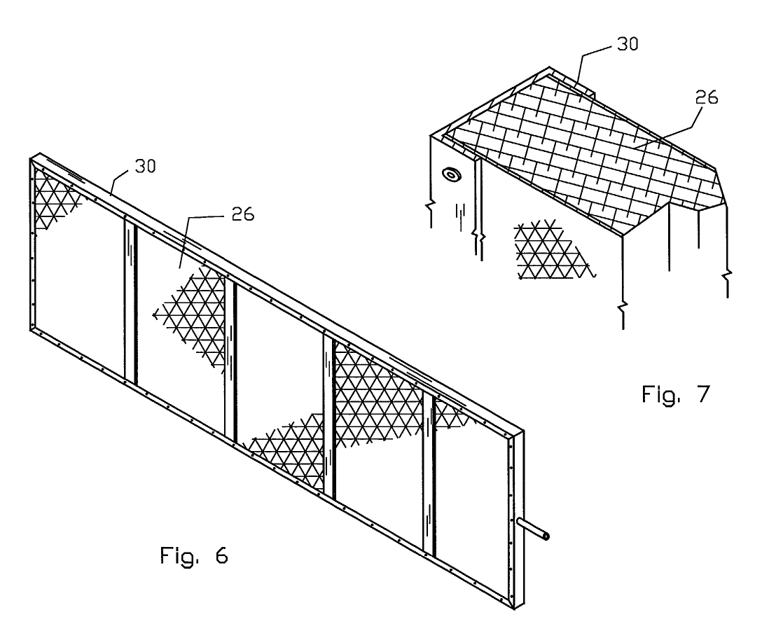

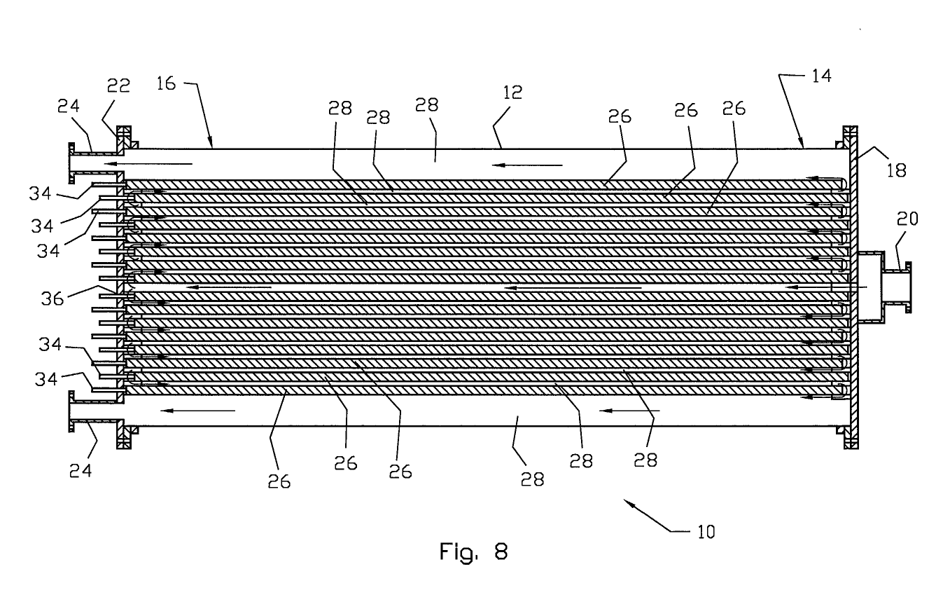

Similar reference numerals refer to similar parts throughout the several views of the drawings.

### DESCRIPTION OF THE PREFERRED EMBODIMENT

Referring now to the drawings, it is seen that the membrane filtration system of the present invention, generally denoted by reference numeral 10, is comprised of a housing 12 having a hollow interior and having a first end 14 and a second end 16 with a first end cap 18 having an inlet port 20 attached to the first end 14 of the housing 12 and a second end cap 22 having at least one outlet port 24 attached to the second end 16 of the housing 12.

A plurality of membrane filters 26, of any appropriate design, are disposed within the housing 12 in generally parallel fashion such that the membrane filters 26 create a plurality of passages 28 that are disposed within the housing 12 in an S-flow pattern, the plurality of passages 28 fluid flow connecting the inlet port 20 with the outlet port 24. As seen, one inlet port 20 can be fluid flow connected to more than one outlet port 24 such that a series of membrane filters 26 creating a plurality of passages 28 are provided between the inlet port 20 and each outlet port 24. In such a design, each membrane filter 26 and passages 28 subsystem is generally identical to the other membrane filter 26 and passages 28 subsystem so that the operation parameters within each subsystem are similar.

Each membrane filter 26 is a generally flat sheet member that is held within a frame 30 with each frame 30 being secured within a first guide 32 disposed within the housing 12 proximate the first end 14 and within a second guide (not illustrated) disposed within the housing 12 proximate the second end 16. The frames 30 are designed so that they are easily removed from their respective guides for servicing or replacement of the membrane filter 26 held within the frame 30.

A plurality of permeate ports 34 are provided and each permeate port 34 is attached to a respective one of the frames 30 of the membrane filters 26 and each permeate port 34 passes through one of the first end cap 18 or second end cap 22 such that permeate collected by the respective membrane filter 26 exits the housing 12 through the permeate port 34.

At least one flange 36 is disposed within the plurality of passages 28 for creating turbulence within a fluid that is flowing within the plurality of passages 28. The at least one flange 34 can be disposed between a connection point between a respective two of the plurality of passages 28 or can be within one of the passages 28.

The membrane filtration system 10 of the present invention is disposed within an overall filtration system 38. The system 38 has a tank 40 that is used to hold the fluid to be filtered. The fluid is circulated through a heating subsystem 42 that heats cold fluid and returns the fluid to the tank 40 such that the fluid is heated. The heated fluid is pumped by an appropriate pump 44, which raises the pressure of the fluid, into the membrane filtration system 10. The fluid enters the membrane filtration system 10 through the inlet port 20 and enters the passages 28 within the housing 12. The fluid flows through the passages 28 before exiting through the outlet port 24. Within the passages 28, the membrane filters 26 are used to remove particles held within the fluid, the exact configuration of the membrane filters being dependent on the size of the particles to be removed and the desired level of fluid purification. The pressure of the fluid within the passages 28 acts on both sides of each membrane filter 26, the fluid acts on a first surface of the membrane filter 26 within a first passage 28 and acts on a second surface of the membrane filter 26 within an adjacent second passage 28. This results in pressure equilibrium on each membrane filter 26 thereby preventing the filter 26 from becoming warped or otherwise damaged by the high pressure fluid flowing through the device 10. The membrane filters 26 trap particles contained within the fluid and hold the particles therein. The dual pressure on each side of the membrane filter 26 causes the particles (permeate) to be pushed toward and out of the permeate port 34 that passes through one of the end caps 18 or 22 wherein the permeate is collected for subsequent processing or disposal. The filtered fluid passes through the outlet port 24 and is returned to the tank 40. This process is repeated until the desired level of fluid filtration is achieved whereby the fluid is removed from the tank 40 and new fluid is introduced into the tank 40 in order to begin the process anew. Any vapor found within the tank 40 is removed by an appropriate vapor recovery subsystem 46. The flanges 36 disposed within the passages 28 increase the turbulence of the fluid flowing through the passages 28. This increased turbulence of the fluid causes greater interaction between the fluid and the membrane filters 26 thereby increasing the filtering capability of the membrane filters 26 for a given flow of fluid.

In order to clean the membrane filters 26, the system 10 can be back flushed such that appropriate cleaning fluid is pumped through the outlet port 24 and exits the housing 12 through the inlet port 20, the exiting fluid containing debris formerly held by the membrane filters 26. Alternately, the membrane filters 26 can be removed and cleaned or replaced as desired.

While the invention has been particularly shown and described with reference to an embodiment thereof, it will be appreciated by those skilled in the art that various changes in form and detail may be made without departing from the spirit and scope of the invention.

I claim:

1. A filter comprising a housing having an inlet port and an outlet port such that a plurality of passages are disposed within the housing in an S-flow pattern, the plurality of passages fluid flow connecting the inlet port with the outlet port and such that each of the plurality of passages is bounded on at least one side by a membrane filter.

2. The filter as in claim 1 further comprising at least one flange disposed within the plurality of passages for creating turbulence within a fluid flowing within the plurality of passages.

3. The filter as in claim 2 wherein the at least one flange is disposed between a connection point between a respective two of the plurality of passages.

4. The filter as in claim 1 wherein each membrane filter is a generally flat sheet member held within a frame.

5. The filter as in claim 4 wherein each frame is secured within a first guide attached to a first end of the housing and within a second guide attached to a second end of the housing.

6. The filter as in claim 1 further comprising a plurality of permeate ports, each attached to a respective one of the membrane filters and each terminating outside of the housing.

7. A filter comprising:
a housing having a first end and a second end;
a first end cap having an inlet port attached to the first end of the housing;
a second end cap having an outlet port attached to the second end of the housing; and
a plurality of membrane filters disposed within the housing in generally parallel fashion such that the membrane filters create a plurality of passages that are disposed within the housing in an S-flow pattern, the plurality of passages fluid flow connecting the inlet port with the outlet port.

8. The filter as in claim 7 further comprising at least one flange disposed within the plurality of passages for creating turbulence within a fluid flowing within the plurality of passages.

9. The filter as in claim 8 wherein the at least one flange is disposed between a connection point between a respective two of the plurality of passages.

10. The filter as in claim 7 wherein each membrane filter is a generally flat sheet member held within a frame.

11. The filter as in claim 10 wherein each frame is secured within a first guide attached to a first end cap and within a second guide attached to the second end cap.

12. The filter as in claim 7 further comprising a plurality of permeate ports, each attached to a respective one of the membrane filters and each passing through the second end cap.

13. A method for filtering a fluid comprising the steps of:
providing a tank for holding the fluid;
providing a heating system for heating the fluid held within the tank;
providing a filtering system for filtering the fluid;
pumping the fluid through the filtering system such that the filtered fluid is pumped back to the tank and a permeate is removed from the fluid is removed from the filtering system.

14. The method as in claim 13 wherein the filtering system comprises:
a housing having a first end and a second end;
a first end cap having an inlet port attached to the first end of the housing;
a second end cap having an outlet port attached to the second end of the housing; and
a plurality of membrane filters disposed within the housing in generally parallel fashion such that the membrane filters create a plurality of passages are disposed within the housing in an S-flow pattern, the plurality of passages fluid flow connecting the inlet port with the outlet port.

15. The method as in claim 14 wherein at least one flange is disposed within the plurality of passages for creating turbulence within a fluid flowing within the plurality of passages.

16. The method as in claim 15 wherein the at least one flange is disposed between a connection point between a respective two of the plurality of passages.

17. The method as in claim 14 wherein each membrane filter is a generally flat sheet member held within a frame.

18. The method as in claim 17 wherein each frame is secured within a first guide attached to the first end cap and within a second guide attached to the second end cap.

19. The method as in claim 14 wherein the permeate is removed by providing a plurality of permeate ports, each attached to a respective one of the membrane filters and each passing through the second end cap and pumping the permeate through the permeate ports.
